(19) United States
(12) Patent Application Publication
(10) Pub. No.: US 2013/0138540 A1
(43) Pub. Date: May 30, 2013

(54) PROJECT MANAGEMENT

(71) Applicants: James Nobel Miner, Lake Oswego, OR (US); Ronald Raymond Edwards, Vancouver, WA (US)

(72) Inventors: James Nobel Miner, Lake Oswego, OR (US); Ronald Raymond Edwards, Vancouver, WA (US)

(73) Assignee: Surepay, LLC, Vancouver, WA (US)

(21) Appl. No.: 13/305,638

(22) Filed: Nov. 28, 2011

(51) Int. Cl. G06Q 30/04

(52) U.S. Cl. 705/30

(57) ABSTRACT

In various embodiments, apparatus, systems, computer-readable media (including non-transitory computer-readable media) and methods for managing a project are provided. In various embodiments, data indicating a first contractual obligation of a first entity to a second entity may be stored in computer-readable memory, e.g., by an application server. The application server may receive, from a third entity, an electronic communication including a second contractual obligation to the third entity. The application server may also receive, from the second entity, an electronic communication including an indication that the second entity has approved the second contractual obligation and/or taken no exception to having the first contractual obligation to the second entity reduced by an amount proportional to the obligation. The application server may then store data indicating a third contractual obligation by the first entity to the third entity for an amount equal to the second contractual obligation.

### TECHNICAL FIELD

Embodiments of the present disclosure relate generally to the technical field of data processing, and more specifically to project management.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Many projects, such as construction projects, may be hierarchal. In the construction project context, an entity such as a property owner or property manager may contract with an entity such as a general contractor to construct a building or other structure. The general contractor in turn may contract with entities such as subcontractors to perform various tasks, suppliers to provide various materials, and other vendors such as architects, lawyers, surveyors, and so forth. Subcontractors themselves may contract with other subcontractors to perform sub tasks.

In a multi-tiered and/or hierarchal project, a top tier entity such as a property owner may have a single (or relatively few) contractual obligation to a middle tier entity such as a general contractor. In contrast, a middle tier entity such as a general contractor may have multiple obligations to lower tier entities such as subcontractors and suppliers. A middle tier entity may collect payment from a top tier entity at predetermined times, which may be referred to as “draws” in the context of a construction project. However, until receipt of payment from the top tier entity, the middle tier entity may be obligated to pay lower tier entities such as subcontractors and suppliers at various times. Thus, a middle tier entity in a hierarchal project may need to have considerable cash on hand to keep up with outgoing payments while waiting for incoming payments. This may make it difficult for the middle tier entity to participate in multiple projects at once.

### BRIEF DESCRIPTION OF THE DRAWINGS

In the following detailed description, reference is made to the accompanying drawings which form a part hereof wherein like numerals designate like parts throughout, and in which is shown by way of embodiments that illustrate principles of the present disclosure. It is to be understood that other embodiments may be utilized and structural or logical changes may be made without departing from the scope of the present disclosure. Therefore, the following detailed description is not to be taken in a limiting sense, and the scope of embodiments in accordance with the present disclosure is defined by the appended claims and their equivalents.

FIG. 1 schematically illustrates components that may be involved in a project such as a construction project, in accordance with various embodiments.

FIG. 2 depicts schematically example communications between devices associated with various entities in a project, in accordance with various embodiments.

FIGS. 3 and 4 depict an example method, in accordance with various embodiments.

FIG. 5 schematically depicts an example system on which various disclosed methods may be implemented, in accordance with various embodiments.

### DETAILED DESCRIPTION

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific devices and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise.

In providing some clarifying context to language that may be used in connection with various embodiments, the phrases “NB” and “A and/or B” mean (A), (B), or (A and B); and the phrase “A, B, and/or C” means (A), (B), (C), (A and B), (A and C), (B and C) or (A, B and C).

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

While examples and figures disclosed herein refer often to “construction projects,” this is not meant to be limiting. The systems and methods disclosed herein are applicable in any hierarchal project, of which construction projects are only an example. Disclosed systems and methods may be equally applicable with hierarchal projects in other industries, including but not limited to hospitality, manufacturing, legal, financial, and so forth.

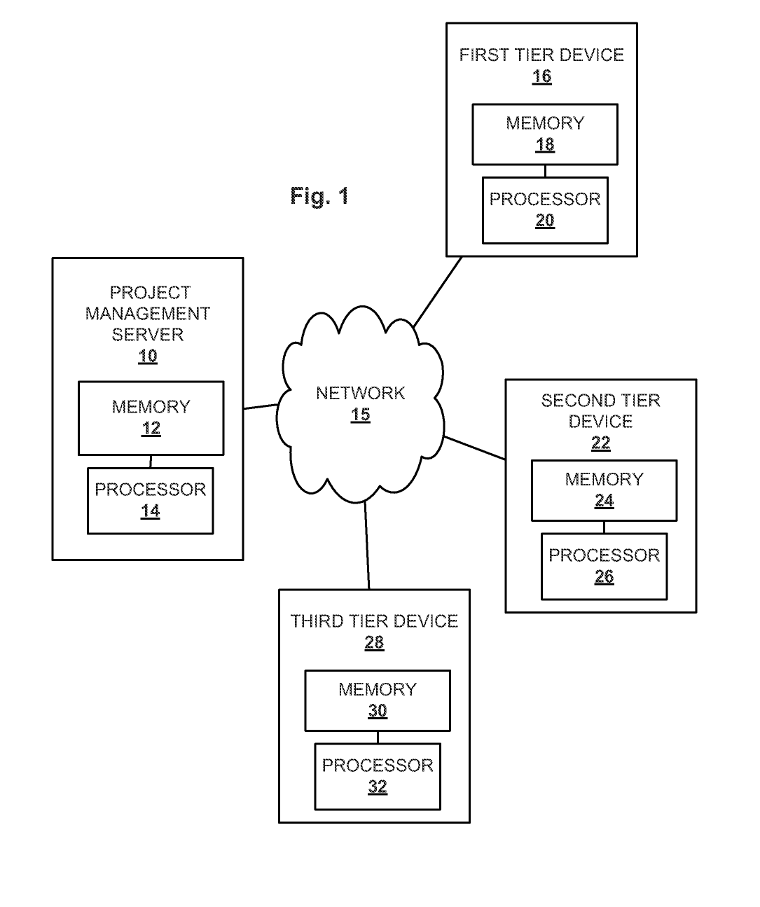

Referring to FIG. 1, a project management server 10 may be a computer system including memory 12 and one or more processors 14. Project management server 10 may be used in a variety of hierarchal projects, including but not limited to construction projects. Although shown as a single unit, project management server 10 and other computer systems described herein may include multiple units.

Project management server 10 may communicate with other computer systems via a computer network 15. Computer network 15 may include one or more local area networks or wide area networks such as the Internet. As will be described below, in various embodiments, project management server 10 may be configured to facilitate waiver by a second tier entity of all or a portion of a first obligation owed to the second tier entity by a first tier entity in response to the first tier entity satisfying a second obligation of the second tier entity to a third tier entity. Additionally or alternatively, a project management server 10 may be configured to track obligations of a first entity of a hierarchy of project entities to a second entity of the hierarchy that is lower than the first entity in the hierarchy. The project management server 10 further may be configured to receive a notification of an obligation to a third entity lower than the first and second entities, and upon satisfaction of the obligation to the second entity, to alter at least one of the obligations of the first entity to the second project entity to reflect the satisfaction.

A device 16 associated with a first tier entity may also be connected to computer network 15. First tier device 16 may include memory 18 and one or more processors 20. As used herein, “a first tier entity” may refer to an entity in a hierarchal project such as a construction project that primarily or exclusively manages other project entities. For example, a property owner or property management company may be first tier construction project entities. In some embodiments, a first tier entity may simply be any entity that is higher up a chain of command than two other levels of entities. For example, where subcontractors contract out subtasks to other subcontractors, a general contractor may be considered a first tier entity relative to the subcontractor.

A device 22 associated with a second tier entity may also be connected to computer network 15. Second tier device 22 may include memory 24 and one or more processors 26. As used herein, a “second tier entity” may refer to an entity that has one or more entities above it to which it answers and one or more subordinate entities below it. For example, a general contractor may be in some instances considered a “second tier entity” because it is beholden to a property owner (a “first tier entity”) and in charge of one or more subcontractors or suppliers (“third tier entities”). Likewise, a subcontractor that hires other subcontractors may be considered a second tier entity relative to those hired subcontractors.

A device 28 associated with a third tier project entity may also be connected to computer network 15. Third tier device 28 may include memory 30 and one or more processors 32. As used herein, a “third tier entity” may refer to an entity that has two or more levels of entities above it. For example, a subcontractor may be a third tier entity to a general contractor (“second tier”) and property owner (“first tier”). Devices 16, 22 and 28 may be various types of computer systems, such as desktop computers, laptops, tablets, smart phones, and so forth. They may be connected to computer network 15 using various techniques, such as wired, wireless, and so forth. While only a single device is shown at each tier in FIG. 1, any number of devices may connect to network on behalf of an entity at any tier.

In various embodiments, entities may interact with project management server 10 in various ways. For example, a user associated with an entity may interact with a computer program (e.g., a client) executing on a device (e.g., 16, 22, 28). That computer program may communicate with another computer program (e.g., a server) executing on project management server 10. In some embodiments, project management server 10 may provide an interface such as a webpage to a device, and a user of the device may use a client computer program such as a web browser to view and interact with the interface. In some embodiments, a client-server application designed specifically for project management may be implemented, with a server portion executing on project management server 10 and client portions executing on devices (e.g., 16, 22, 28).

In various embodiments, entities may enroll to interact with project management server 10. During the enrollment process, entities may provide various information, including but not limited to financial information (e.g., bank account numbers), demographic information (e.g., company size, address) and so forth. In various embodiments, this information may be stored, e.g., in memory 12, and may be used in one or more projects.

In various embodiments, entities may be required to agree to terms of use prior to being permitted to use the system. For example, a third tier entity such as a subcontractor or supplier may be required to agree to waive any lien for any obligation to the entity, but that waiver may be conditional upon satisfaction of the obligation by another entity (e.g., receipt of payment for an invoice amount). This may facilitate subsequent generation, e.g., by project management server 10, of legally-enforceable documents including enforceable lien waivers.

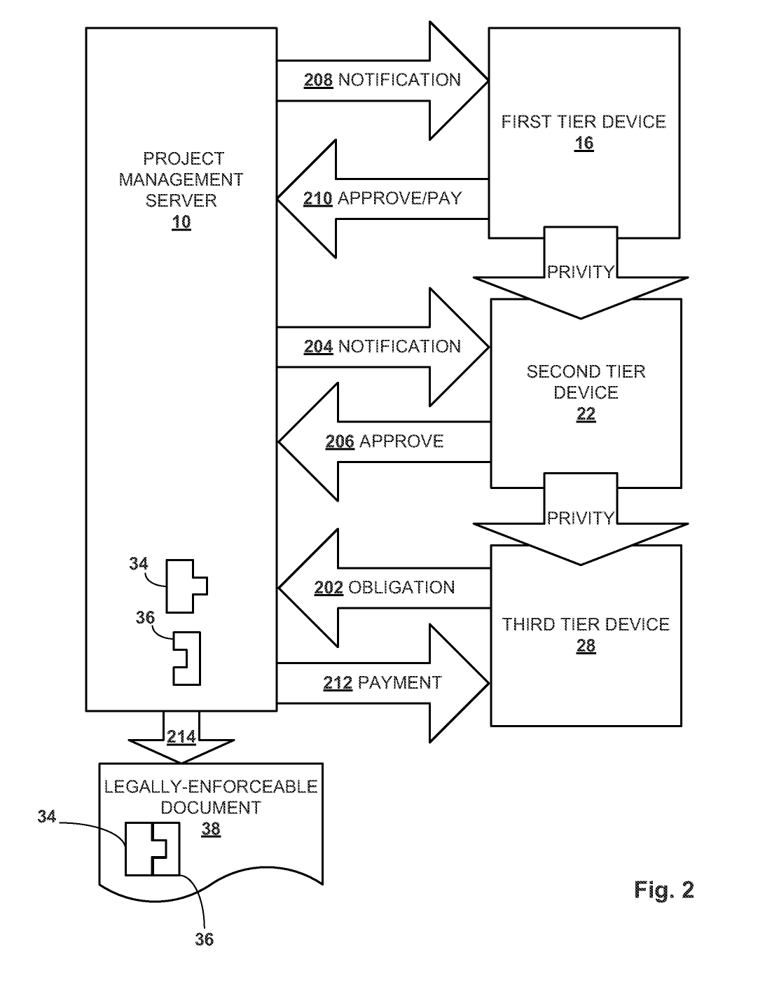

Referring now to FIG. 2, example communications that may be exchanged between various devices are shown, in accordance with various embodiments. These example communications are non-limiting, and in various embodiments, other communications may be added and some of the depicted communications may be omitted. Moreover, the communications may be exchanged in orders different than that shown without departing from the present disclosure.

At 202, third tier device 28 may transmit (e.g., over computer network 15), to project management server 10, an electronic communication indicating an obligation to a third tier entity using third tier device 28. For example, a subcontractor may log into a website hosted by project management server 10 and submit an invoice amount for services rendered by the subcontractor. The invoice amount may be submitted by the subcontractor by uploading an electronic file (e.g., a portable data format, or “PDF,” document) or through a webpage interface.

In various embodiments, when an obligation such as an invoice amount is received at project management server 10, a first electronic token 34 may be stored by project management server 10. First electronic token 34 may evidence a conditional waiver by the third tier entity of the obligation to the third tier entity for the invoice amount. As used herein, an “electronic token” may refer to any sequence of computer-readable symbols and/or characters that may represent one or more pieces of information, including but not limited to a state, or occurrence of one or more events. In various embodiments, electronic tokens may be usable or combinable with other electronic tokens to represent other pieces of information and/or to facilitate various actions (e.g., generation of legally-enforceable documents).

In some embodiments, the waiver evidenced by first electronic token 34 may be conditional upon another event (e.g., receipt of payment), and therefore not enforceable as a waiver until occurrence of that event. A second electronic token 36 evidencing satisfaction of the condition may be combined with first electronic token 34 to facilitate generation (automatic or by request) of a legally-enforceable electronic document 38 that includes a legally-enforceable waiver of the obligation by the third tier entity.

At 204, a notification may be transmitted by project management server 10 to second tier device 22. In various embodiments, this notification may include a request that the second tier entity review the invoice amount that third tier device 28 transmitted to project management server 10 at 202 and provide feedback. For example, the notification may include the invoice amount with other invoice data (e.g., the services rendered, when services were rendered, material costs). In some embodiments, the notification may be an electronic communication directed to a second tier entity such as a general contractor.

In various embodiments, the notification may include a request that the second tier entity indicate whether it “takes exception” to the invoice amount. For example, the notification may include a link to a webpage or other user interface that may provide a mechanism (e.g., checkbox, select box) that may be used at 206 to indicate whether the second tier entity takes exception to the invoice amount requested by the third tier entity at 202. As used herein, to “take exception” to an invoice amount may mean to refuse to allow a contractual obligation owed by another entity to be reduced.

For example, if the second tier entity does not agree with the invoice amount it receives in the notification at 204, the second tier entity may indicate that it takes exception to reducing a contractual obligation owed to it by a first tier entity by the invoice amount. On the other hand, if the second tier entity “takes no exception” to an invoice amount, the second tier entity may be indicating that it agrees to have the contractual obligation owed to it by the first tier entity reduced by the invoice amount. In some embodiments, the second entity not taking exception to the invoice amount results in a contractual obligation between the first tier entity and the third tier entity for the invoice amount. Put another way, by taking no exception, at least some of a contractual obligation owed to the second tier entity by the first tier entity may “shift” to become a contractual obligation by the first tier entity to the third tier entity. First tier and third tier entities may agree to accept such a contractual relationship when they sign up to use the system, as part of the system's terms of use.

At 208, a notification may be transmitted by project management server 10 to first tier device 16. In various embodiments, this notification may include a request for approval of the invoice amount that third tier device 28 transmitted to project management server 10 at 202. It may be transmitted via electronic communication techniques. For example, a property owner organization or property management organization may be notified of an invoice submitted by a third tier subcontractor, and in some cases may be requested to approve or deny the invoice amount, or even pay the invoice amount to the third tier subcontractor.

At 210, first tier device 16 may be used to approve and/or satisfy the obligation. A first tier entity may satisfy the obligation in various ways. In some embodiments, first tier device 16 may be used to instruct project management server 10 (e.g., at 210) to initiate a payment to the third tier entity at 212, e.g., using banking information about the third tier entity that may be stored in memory 12 of project management server 10. In some embodiments, payment to the third tier entity at 212 may be implemented using electronic checks, credit cards, electronic wire transfers, automated clearinghouse payments, and any other method of electronic payment. In addition to payment being made through project management server 10, in some embodiments, a first tier entity may pay a third tier entity directly, and then transmit a notification to project management server 10 that payment has been made. In some embodiments, the third tier entity may, through third tier device 28, transmit a notification to project management server 10 that payment was received from the first tier entity.

In any case, upon satisfaction of the obligation to the third tier entity by the first tier entity at 212, a second electronic token 36 may be generated and/or stored by project management server 10. Thereafter, a legally-enforceable electronic document 38 including an enforceable waiver may be generated at 214, e.g., by project management server 10, using first electronic token 34 and second electronic token 36. For example, as shown in FIG. 2, first electronic token 34 and second electronic token 36 may be combined to form part or all of legally-enforceable electronic document 38, or to otherwise facilitate generation of legally-enforceable electronic documents 38.

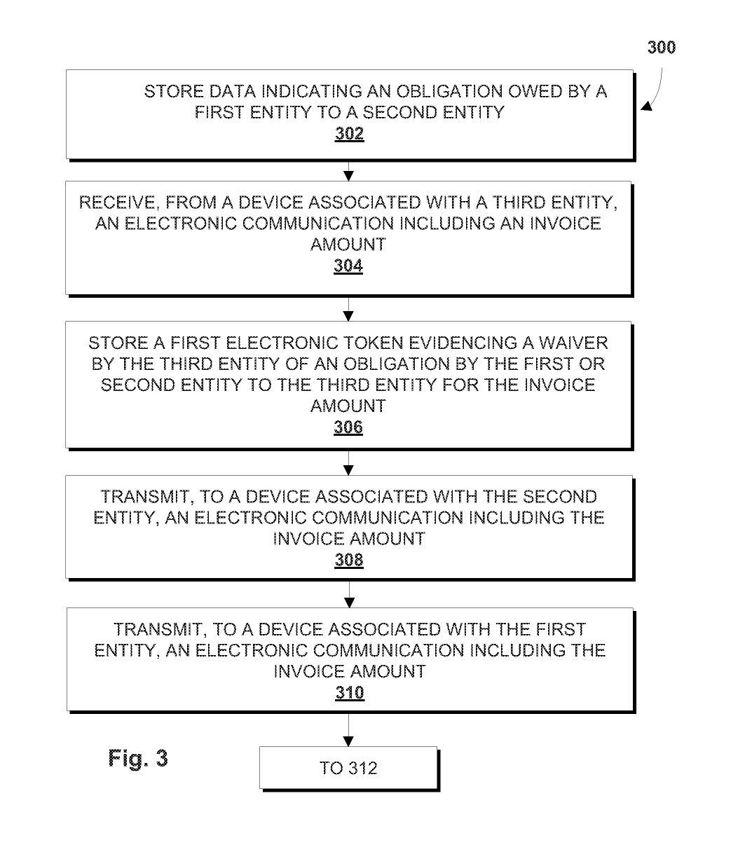

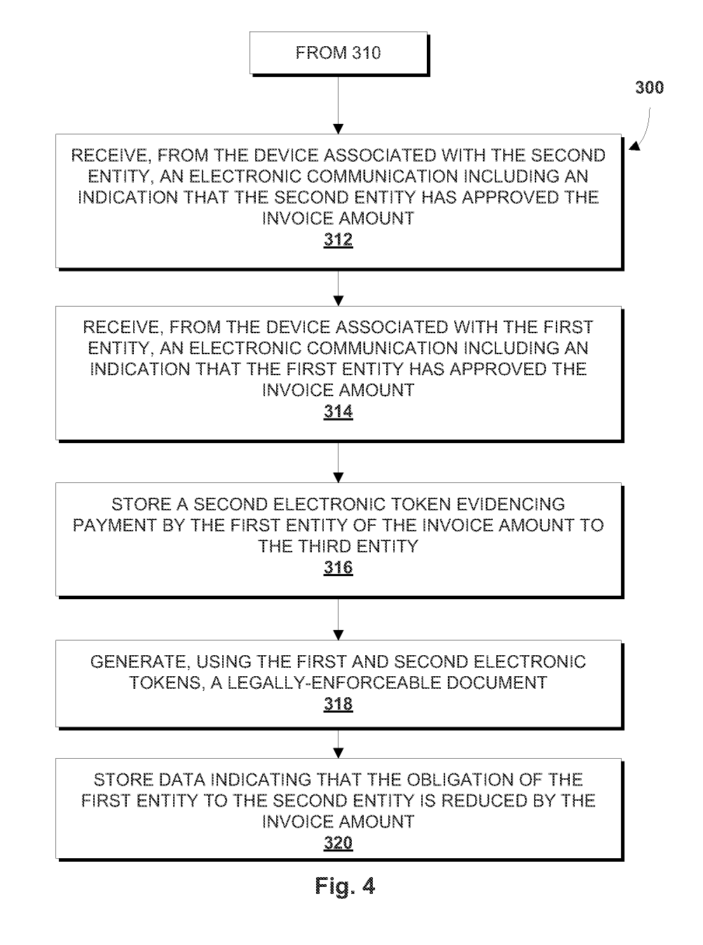

An example method 300 that may be implemented by project management server (e.g., 10) is depicted schematically in FIGS. 3 and 4. As with FIG. 2, various actions may be altered, reordered, added and/or omitted without departing from the present disclosure. For purposes of explanation, assume that a first entity/property owner has contracted to pay a second entity/general contractor a million dollars to build a structure. Assume also the general contractor hires a single third entity/subcontractor to perform a particular service for $100,000.

At 302, data indicating an obligation owed by a first entity to a second entity may be stored, e.g., by project management server 10, in memory 12. For example, data indicating the million-dollar obligation by the property owner to the general contractor may be stored in memory.

At 304, an electronic communication may be received, e.g., by project management server 10, from a device (e.g., 28) associated with a third entity in a hierarchal project. The electronic communication may include an invoice amount, such as the $100,000 owed by the general contractor to the subcontractor. This may be similar to the electronic communication 202 of FIG. 2.

At 306, a first electronic token (e.g., 34) may be stored, e.g., by project management server 10, in memory such as memory 12. The first electronic token may evidence a waiver by the third entity (e.g., the subcontractor) of an obligation (e.g., the $100,000) by the first entity (e.g., the property owner) or second entity (e.g., the general contractor) to the third entity for the invoice amount. In some embodiments, the waiver evidenced by the first electronic token may only take effect upon receipt by project management server 10 of evidence that a condition has been satisfied; e.g., that the third entity (e.g., the subcontractor) has been paid.

At 308, an electronic communications may be transmitted, e.g., by project management server 10, to devices (e.g., 22) associated with a second entity (e.g., the subcontractor). In some embodiments, this communication may be transmitted in response to project management server 10 receiving the communication at 302. This electronic communication may include the invoice amount and/or a request for feedback from the second entity, similar to 204 in FIG. 2. For example, this communication may include a request that the general contractor indicate whether it takes exception to the invoice amount of $100,000 received at 304.

At 310, an electronic communication may be sent to the first entity (e.g., the owner) with the invoice amount. In some embodiments this electronic communication may also include a request for feedback (e.g., approval, whether the first entity takes exception, etc.) regarding the invoice amount. In some embodiments, the electronic communication of 310 may simply be a request for payment of the invoice amount.

At 312, an electronic communication may be received, e.g., by project management server 10, from the second entity that may include an indication of whether the second entity takes exception to the obligation received at 302. In the illustrative example, if the general contractor takes no exception to the invoice amount, a contractual obligation may be triggered between the owner and the subcontractor. The owner agrees to pay the subcontractor, and the subcontractor agrees that, upon receipt of payment, the subcontractor has waived any lien against the owner.

At 314, an electronic communication may be received, e.g., by project management server 10, from the first entity that may include feedback from the first entity regarding the invoice amount. For example, the first entity may approve or disapprove the invoice amount. In some embodiments, the first entity may simply pay the third entity the invoice amount.

At 316, a second electronic token (e.g., 36) may be generated and stored, e.g., by project management server 10, in memory such as memory 12. As noted above, the second electronic token 36 may evidence satisfaction (e.g., payment) by the first entity of the obligation (e.g., invoice amount) to the third entity received at 302. For example, once the property owner pays the subcontractor $100,000 (e.g., at 314), second electronic token 36 may be generated and/or stored.

At 318, a legally-enforceable electronic document (e.g., 38) may be generated, e.g., by project management server 10, using the first and second electronic tokens. For example, the property owner or general contractor may request and receive a legally-enforceable electronic document that includes an enforceable lien waiver by the subcontractor of the invoice amount of $100,000.

At 320, stored data indicating the obligation of the first entity to the second entity may altered (e.g., reduced by the invoice amount) to reflect satisfaction of the obligation to the third entity. In various embodiments, this may occur in response to the project management server receiving approval from the second entity (e.g., general contractor) of the invoice amount at 312. In some embodiments, approval from the first entity (e.g., property owner) may also be required (e.g., at 314) before the obligation of the first entity to the second entity is reduced. In the example scenario described above, if the property owner pays the subcontractor the entire invoiced amount of $100,000, then the general contractor no longer owes the subcontractor the $100,000. Therefore, the amount owed to the general contractor by the property owner (one million dollars) may be reduced by $100,000. Thus, project management server 10 may now store data indicating the property owner owes the general contractor $900,000.

In other words, instead of paying a third tier entity such as a subcontractor directly, a second tier entity such as a general contractor may now waive a portion of an obligation of a first tier entity such as a property owner, and allow the property owner's outgoing financial obligation to shift from the general contractor to the subcontractor. In this way, a second tier entity such as a general contractor may no longer require as much cash on hand to pay subcontractors, and may be able to bid for more jobs.

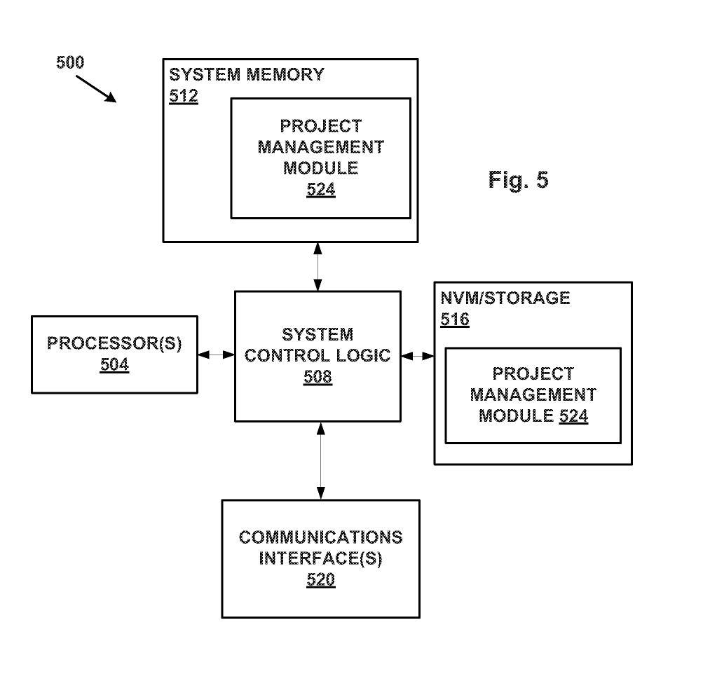

The techniques and apparatus described herein may be implemented into a system using suitable hardware and/or software to configure as desired. FIG. 5 illustrates, for one embodiment, an example system 500 including one or more processor(s) 504, system control logic 508 coupled to at least one of the processor(s) 504, system memory 512 coupled to system control logic 508, non-volatile memory (“NVM”)/storage 516 coupled to system control logic 508, and one or more communications interface(s) 520 coupled to system control logic 508.

System control logic 508 for one embodiment may include any suitable interface controllers to provide for any suitable interface to at least one of the processor(s) 504 and/or to any suitable device or component in communication with system control logic 508.

System control logic 508 for one embodiment may include one or more memory controller(s) to provide an interface to system memory 512. System memory 512 may be used to load and store data and/or instructions, for example, for system 500. System memory 512 for one embodiment may include any suitable volatile memory, such as suitable dynamic random access memory (“DRAM”), for example.

System control logic 508 for one embodiment may include one or more input/output (“I/O”) controller(s) to provide an interface to NVM/storage 516 and communications interface(s) 520.

NVM/storage 516 may be used to store data and/or instructions, for example. NVM/storage 516 may include any suitable non-volatile memory, such as flash memory, for example, and/or may include any suitable non-volatile storage device(s), such as one or more hard disk drive(s) (“HDD(s)”), one or more solid-state drive(s), one or more compact disc (“CD”) drive(s), and/or one or more DVD drive(s) for example.

The NVM/storage 516 may include a storage resource physically part of a device on which the system 500 is installed or it may be accessible by, but not necessarily a part of, the device. For example, the NVM/storage 516 may be accessed over a network via the communications interface(s) 520.

System memory 512 and NVM/storage 516 may include, in particular, temporal and persistent copies of a project management module 524, respectively. The project management module 524 may include instructions that when executed by at least one of the processor(s) 504 result in the system 500 performing operations to manage projects, as described above. In some embodiments, the project management module 524 may additionally/alternatively be located in the system control logic 508.

Communications interface(s) 520 may provide an interface for system 500 to communicate over one or more network(s) and/or with any other suitable device. Communications interface(s) 520 may include any suitable hardware and/or firmware. Communications interface(s) 520 for one embodiment may include, for example, a wireless network adapter.

For one embodiment, at least one of the processor(s) 504 may be packaged together with logic for one or more controller(s) of system control logic 508. For one embodiment, at least one of the processor(s) 504 may be packaged together with logic for one or more controllers of system control logic 508 to form a System in Package (“SiP”). For one embodiment, at least one of the processor(s) 504 may be integrated on the same die with logic for one or more controller(s) of system control logic 508. For one embodiment, at least one of the processor(s) 504 may be integrated on the same die with logic for one or more controller(s) of system control logic 508 to form a System on Chip (“SoC”).

The system 500 may be a desktop or laptop computer, a mobile telephone, a smart phone, a game console, a set-top box, or any other device adapted to operate a client or server portion of a client-server application. In various embodiments, system 500 may have more or less components, and/or different architectures.

Although specific embodiments have been illustrated and described herein, it is noted that a wide variety of alternate and/or equivalent implementations may be substituted for the specific embodiment shown and described without departing from the scope of the present disclosure. The present disclosure covers all methods, apparatus, and articles of manufacture fairly falling within the scope of the appended claims either literally or under the doctrine of equivalents. This application is intended to cover any adaptations or variations of the embodiment disclosed herein. Therefore, it is manifested and intended that the present disclosure be limited only by the claims and the equivalents thereof.

What is claimed is:

1-9. (canceled)

10. A non-transitory computer-readable storage medium having stored therein a plurality of instructions configured to provide an apparatus, in response to execution of the instructions by the apparatus, with a project management module, wherein the project management module is configured to:
facilitate waiver by a first project entity of a right to a lien, the right to the lien based at least in part on a first contractual obligation owed to the first project entity by a second project entity;
in response to the waiver by the first project entity, create a second contractual obligation of a third project entity to the first project entity, the second contractual obligation being equal to the first contractual obligation; and
store in memory associated with the apparatus data indicating the second contractual obligation.

11. A non-transitory computer-readable medium having computer-readable code embodied therein, the computer-readable code comprising instructions configured to enable a server computer system, in response to execution of the instructions, to perform a number of operations, including:
receiving, from a first device associated with a first entity, a first electronic communication including an invoice amount;
in response to receiving the first electronic communication, storing in computer-readable memory a first electronic token evidencing a waiver by the first entity of a right to a lien, the right to the lien based at least in part on a contractual obligation to the first entity for the invoice amount, the waiver being conditioned upon the first entity receiving payment satisfying the contractual obligation;
storing in computer-readable memory a second electronic token evidencing payment by a second, or a third -entity to the first entity of the invoice amount; and
using the stored first and second electronic tokens, facilitating generation of a waiver by the first entity of the contractual obligation to the first entity for the invoice amount.

12. The non-transitory computer-readable medium of claim 11, wherein the operations further include, in response to receiving the first electronic communication, transmitting, to a device associated with the third entity, a second electronic communication including the invoice amount.

13. The non-transitory computer-readable medium of claim 12, wherein the second electronic communication further includes a request for approval of the invoice amount by the third entity.

14. The non-transitory computer-readable medium of claim 13, wherein the operations further include, in response to receiving the first electronic communication, transmitting, to a device associated with the second entity, a third electronic communication including the invoice amount.

15. The non-transitory computer-readable medium of claim 14, wherein the second electronic communication and the third electronic communication are substantially similar.

16. The non-transitory computer-readable medium of claim 13, wherein the third electronic communication further includes a request for approval of the invoice amount by the second entity.

17. The non-transitory computer-readable medium of claim 13, wherein the operations further include receiving, from the device associated with the second entity, a fourth electronic communication including an indication that the second entity has approved the invoice amount.

18-20. (canceled)

21. A computer-implemented method, comprising:
receiving, by a computing device, a first electronic communication including an invoice amount from a first entity;
in response to receiving the first electronic communication, storing, in computer-readable memory of the electronic device, a first electronic token evidencing a waiver by the first entity of a right to a lien, the right to the lien based at least in part on a contractual obligation to the first entity for the invoice amount, the waiver being conditioned upon the first entity receiving payment satisfying the contractual obligation;
storing, in computer-readable memory of the computing device, a second electronic token evidencing payment by a second or third entity to the first entity of the invoice amount; and
using the stored first and second electronic tokens, facilitating, by the computing device, generation of a waiver by the first entity of the contractual obligation to the first entity for the invoice amount.

22. The method of claim 21, further comprising, in response to receiving the first electronic communication, the computing device transmitting, to the third entity, a second electronic communication including the invoice amount.

23. The method of claim 22, wherein the second electronic communication further includes a request for approval of the invoice amount by the third entity.

24. The method of claim 23, further comprising, in response to receiving the first electronic communication, the computing device transmitting, by the computing device to the second entity, a third electronic communication including the invoice amount.

25. The method of claim 24, wherein the second electronic communication and the third electronic communication are substantially similar.

26. The method of claim 23, wherein the third electronic communication further includes a request for approval of the invoice amount by the second entity.

27. The method of claim 23, further comprising receiving, by the computing device from the second entity, a fourth electronic communication including an indication that the second entity has approved the invoice amount.

28. The method of claim 23, further comprising the computing device receiving approval of the invoice amount by the third entity.

29. The method of claim 28, wherein further comprising the computing device storing in the computer-readable memory of the computing device data indicating a contractual obligation of the third entity to the first entity for the invoice amount.

30. The method of claim 21, wherein the first electronic token further evidences a waiver by the first entity of a the contractual obligation to the first entity for the invoice amount.

31. The computer-readable medium of claim 13, wherein the operations further include receiving approval of the invoice amount by the third entity.

32. The computer-readable medium of claim 31, wherein the operations further include in response to the receiving the approval, storing in the computer-readable memory data indicating a contractual obligation of the third entity to the first entity for the invoice amount.

33. The computer-readable medium of claim 13, wherein the first entity is a subcontractor or supplier, the second entity is a general contractor, and the third entity is a property owner or management entity.

34. The computer-readable medium of claim 11, wherein the first electronic token further evidences a waiver by the first entity of a the contractual obligation to the first entity for the invoice amount.
